(19) United States
(12) Patent Application Publication
(10) Pub. No.: US 2017/0216633 A1
(43) Pub. Date: Aug. 3, 2017

(54) COMPRESSION AUGMENTED FULL PRESSURE SUIT SYSTEM

(71) Applicant: ILC DOVER IP, INC., Frederica, DE (US)

(72) Inventor: David Phillip Cadogan, Middletown, DE (US)

(21) Appl. No.: 15/413,925

(22) Filed: Jan. 24, 2017

Related U.S. Application Data
(60) Provisional application No. 62/289,981, filed on Feb. 2, 2016.

(51) Int. Cl. A62B 17/00; B64G 6/00; A62B 18/04; A41D 13/12; A41D 13/005; A41D 13/02

(52) U.S. Cl. CPC A62B 17/008; A41D 13/005; A41D 13/02; A62B 17/005; A62B 18/04; A41D 13/1281; B64G 6/00; A41D 2400/44

(57) ABSTRACT

The compression augmented full-pressure suit system includes a garment configured to protect humans in low to zero atmospheric pressure environments while providing excellent mobility. The suit system includes a specialized compression garment worn over the entirety of the body, with a full pressure suit over that compression garment. The compression garment applies a percentage of the pressure on the human form required for protection in low atmosphere environments. The balance of the pressure that is required comes from pressurization of the full pressure suit. Use of both pressure application methods concurrently enables each component to be greatly simplified in comparison to their configuration when used individually, with the result being greater comfort and performance at a reduced cost.

### CROSS REFERENCE TO RELATED APPLICATIONS

This application is a Non-Provisional Patent Application which claims benefit of Provisional Patent Application Ser. No. 62/289,981, filed Feb. 2, 2016, the entire contents of which are herein incorporated by reference in its entirety and the priority of which is claimed under 35 U.S.C. §119.

### DESCRIPTION

1. Field of the Invention

The present invention relates to protective equipment that is used to allow humans to safely and effectively work in environments with low atmospheric pressure (aircraft, sub-orbital spacecraft, environmental chambers, surface of Mars, etc.), or zero atmospheric pressure (space, vacuum chambers, surface of the moon, etc.).

2. Background of the Invention

Several approaches for protecting humans in low atmospheric to vacuum environments have been used or investigated for use for several decades. These include full pressure suits and mechanical counter-pressure suits. The goal of these suits is to protect the respiratory tract and provide pressure to all surfaces of the body to prevent the conversion of liquids in the body to gasses which would lead to loss of life. Full pressure suits are enclosures which surround the body and provide a pressurized atmosphere for protection. Mechanical counter-pressure suits consist of garments which physically compress the body, and a pressurized helmet which surrounds the head.

Full pressure suits have been used for altitude protection for pilots since the 1950s, and for space exploration since the 1960s. Pressurization of the suits to the minimal levels required to meet human physiological needs (Ex: Apollo space suits operated at 3.8 psid (pounds per square inch differential)¹ pure oxygen) results in high joint torque with limited mobility, which causes fatigue and reduces performance. This is particularly critical in omnidirectional joints such as the shoulder, hips, or torso. Bearings and other rigid components can be added to the suits to reduce joint torque and enhance mobility but are heavy, costly, and not applicable to suits worn during flight in aircraft or during launch and entry of spacecraft. In the case of space exploration the addition of rigid components to space suits has a very negative impact on mission effectiveness and economics. The inability to wear the same space suit for launch/entry and for extravehicular activity (Ex: Space Shuttle paradigm) leads to a two suit system which is costly to develop and maintain, requires more launch mass, and has greater logistics and maintenance implications. ¹The “differential” is between the pressure inside and outside of the suit. It is helpful when you talk about a suit's operation in differing pressure environments (zero-gravity, Mars' surface, high altitude, etc.). Saying a suit operates at, for example, 4.3 psi, doesn't mean much unless you know the external environmental pressure. This way the number is essentially normalized. This is standard practice in the industry.

Mechanical counter-pressure suits have been studied since the 1950s with the first being the Space Activity Suit, but no suit has ever been used operationally. These suits apply compression to the body through elastic textiles, or textiles that are tensioned through the use of pressurized subcomponents, or attached electromechanical devices such as shape memory alloys or electroactive polymers. The goal of development of the technology was to reduce joint torque and enhance mobility over full pressure suits. However, the mechanical counter-pressure suits have several drawbacks that prevent them from practical application. First, the application of the >3 psi pressure to the body is very uncomfortable and elevates blood pressure through compression of the entire vascular system, which yields an unsafe load on the heart. Also, some parts of the human anatomy don't like to be squeezed and pressure application can be painful. Second, it is very difficult to apply uniform and consistent pressure to all surfaces of the body during motion because of near flat contours and concavities on the human form.

Mechanical pressure has been found to have efficacy in medical and sports therapies at considerably lower pressures than the mechanical counter-pressure suits. Elastic textile sleeves that apply under 1 psi to major muscle groups are available commercially. Therapy devices do not require precise pressure application in comparison to that required by mechanical counter-pressure suits because the result of ineffective use is limited to less effective therapy as opposed to a dangerous evolution of gas under the skin that can become life threatening.

The limitations of full pressure suits and mechanical counter-pressure suits, in conjunction with a growing need for more economical solutions for applications such as space exploration with improved comfort and performance, has led to the development of the compression augmented full pressure suit system of the present disclosure.

### SUMMARY

The compression augmented full pressure suit combines the basic approach of full pressure suits and mechanical counter-pressure suits to create a hybrid with better economics and performance than either of the other solutions alone. The compression augmented full pressure suit is not just a simple hybridization of other suit technologies, but includes enhancement of the base approaches to meet performance needs. The compression augmented full pressure suit uses an enhanced compressive body stocking inside a full pressure suit so comfort and mobility are balanced while the body is safely protected from low atmospheric pressures. The inward applied pressure from the compression garment and the pressure the suit applies are additive and can be balanced (passively or actively) to yield the optimal suit system.

The full body stocking mechanically applies approximately 1-2 psi of pressure to the body via a specialized elastic garment similar to those used in sports medicine, but modified to provide a predictable pressure to all surfaces of the body including concave spaces. The elastic garment will include compliant components (Ex: molded foam or gel-filled bags) that fit into concavities, or on flat surfaces, on the body to convert them into convex shapes which can be compressed by the elastic garment such that it transmits its inward compression to the body over its entire surface. It is important to note that the elastic layer can't apply inward pressure on a flat surface and therefore features must be added to keep the elastic in a form as close to a cylinder as feasible to yield a consistent inward pressure. The compression garment preferably is undersized to the body of the wearer in order to apply pressure over the wearer's entire body. The use of the pads described below assures that such compression is also applied to flat and concave areas of the wearer's anatomy.

The full pressure suit will operate at approximately 2-4 psid, depending on the application. Full pressure suits that operate in this range are highly mobile and can be made with textile-based mobility joints to preclude a reliance on rigid mechanical elements such as bearings or rings to create mobility joints. The pressurized suit also provides a means for thermal control and the elimination of sweat from the body via air exchange. Thermal control is maintained by passive insulation applied over the full pressure suit and/or active thermal regulation such as liquid cooling which can be embedded directly into the compression garment or as a separate layer over the compression garment. The thermal regulation system approach is determined by the operational environment (pressure at altitude, vacuum in earth orbit or on the moon, the atmosphere of Mars, etc.).

The compression augmented full pressure suit is mostly compiled of soft flexible elements and is therefore comfortable enough to wear during launch and entry during space flight, but also mobile enough to meet the needs of the crew during emergency cabin depressurization, or use during extravehicular activity in zero gravity or on a planetary surface. The compression augmented full pressure suit is also comfortable and mobile enough to be used for aircraft or suborbital spacecraft that fly at high altitudes.

A helmet covers the head and is pressurized to the standard pressure of a space suit (˜4 psi with 100% oxygen) since no mechanical pressure could be effectively applied to the head. An elastomeric neck dam will provide the seal to the wearer's neck to separate the helmet volume from the suit volume so the helmet pressure can be maintained at a higher level than in the full-pressure suit. This allows the total suit pressure to be lower and therefore improve mobility which is key.

The compression augmented full pressure suit offers a form of safety and redundancy not available in current flight suits or space suits because it has 2 pressure application layers. In the event of loss of function of one layer, the other will provide limited protection to allow the crew to return to safety. Safety will be improved because of reduced operational pressure of the full pressure suit because the potential for burst or tear propagation will be reduced with a lower skin stress in the pressure vessel. The compression augmented full pressure suit also provides better medical safety than mechanical counter-pressure suit alone because it reduces blood pressure and load on heart from increased vascular compression over the entire body.

In extreme cases the amount of compression the compression garment applies, and the pressure at which the full pressure suit operates, can be actively controlled to provide full system redundancy in the event of failure of either component. This is achieved by increasing the pressure of the full pressure suit if the compression garment fails, or increasing the compression the compression garment applies if the full pressure suit fails. In this case the compression garment would include an active system such as capstan tubes that can be pressurized to control tension in the garment similarly to older anti G-suits, or integrated electroactive polymers that can be electronically controlled to increase compression. The addition of this redundancy will, however, add complex control systems and the need for power, so the need must outweigh the system impact.

The compression augmented full pressure suit has significant economic and logistical benefits over the current approach to space exploration because a single suit can be used in place of the two different suits used for launch/entry and extravehicular activity. The single suit system reduces development and manufacture cost, is lower mass and volume which reduces launch costs, reduces logistics through fewer parts to supply and maintain, and reduces crew maintenance time. Conversely, even in a two-suit system or in a scenario such as aircraft or sub-orbital spacecraft, the pressure augmented full pressure suit offers advantages over current suit technologies because it provides enhanced mobility at a reduced system cost.

### BRIEF DESCRIPTION OF DRAWINGS

FIG. 1 is a schematic view of a system assembly with major components, including compression garment (upper torso and lower torso) gloves and socks as well as full pressure suit, including helmet, neck dam, upper and lower torso portions gloves and boots);

FIG. 2 illustrates a schematic front view of a compression garment upper torso, with pads;

FIG. 3 illustrates a schematic rear view of a compression garment upper torso, with pads;

FIG. 4 is a schematic front view of a compression garment lower torso with pads;

FIG. 5 is a schematic rear view of a compression garment lower torso with pads;

FIG. 6 is a schematic cross-sectional view along line 6-6 through the knee pad of FIG. 5;

FIG. 7 is a schematic view of a typical pad shown in the embodiments of the invention;

FIG. 8 is a schematic, partially cross-section view of buttocks pad 213 shown in FIG. 5 in an unstressed condition;

FIG. 9 is a schematic, partially cross section view of buttocks pad 215 of FIG. 8 in a stressed, bent, condition;

FIG. 10 is a schematic representation of the textile utilized in the garments of the various embodiments of the invention illustrating the elastic fibers and inelastic fibers in an unstressed condition;

FIG. 11 is a schematic representation of the textile of FIG. 10 in a stressed condition;

FIG. 12 is a schematic representation of a low pressure mobility joint of the as used in various embodiments; and,

FIG. 13 is a schematic representation of a compression garment illustrating circumferential sizing and length sizing of the torso and arms of a wearer of the compression garment.

### DETAILED DESCRIPTION OF THE PREFERRED EMBODIMENTS

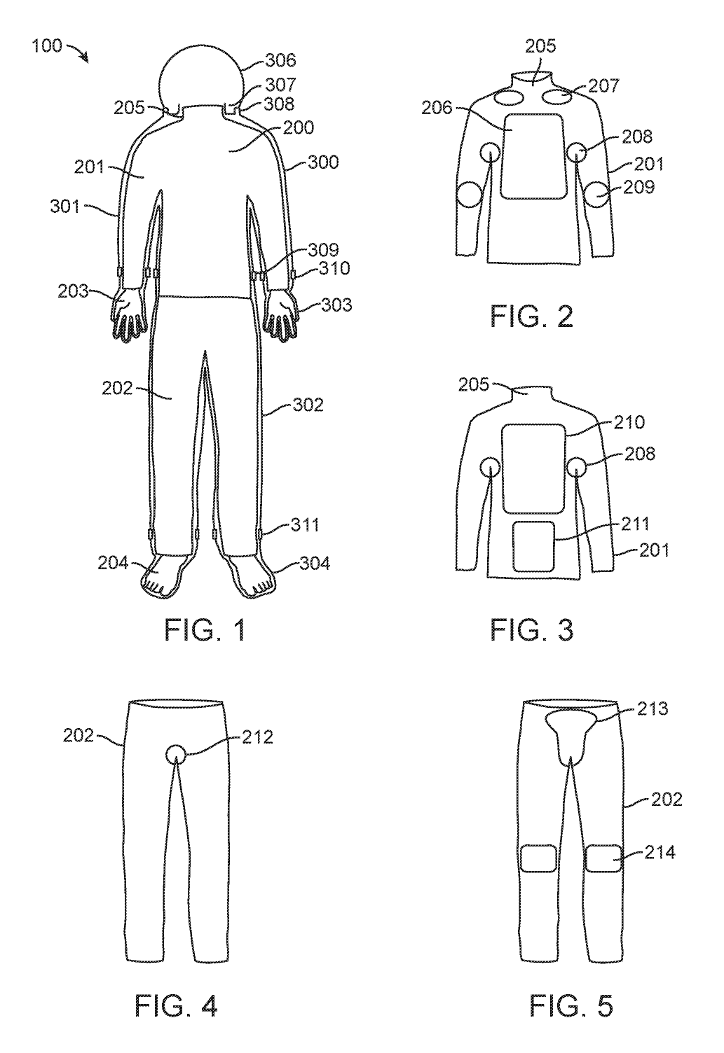

As shown in FIG. 1, the compression augmented full pressure suit 100 comprises a full pressure suit 300, which is comprised of principally textile and coated fabric materials, and a compression garment 200, which is worn under the full pressure suit 300, which compression garment 200 is comprised of principally textile materials. The two components of the compression augmented full pressure suit 100 work in unison to provide a combined atmospheric and mechanical pressure to the skin of the wearer to facilitate protection of humans in low to zero-pressure atmospheres. In combined form, the components can be operated at lower stress than when used individually, which is highly beneficial in the performance of protective equipment. When used in unison, the full pressure suit 300 can be operated at a lower working pressure, and the compression garment can be designed with lower mechanical compression. The result in the case of the compression augmented full pressure suit 100 is reduced joint torque, greater mobility, and the elimination of rigid components to enhance comfort and reduce cost. Operating the compression garment 200 at a lower compression point dramatically improves comfort, increases mobility, and is medically safer. As a system, this approach opens the solution architecture to a facilitate the use of a greater number of materials options, configurations options, and applications than when considering use of full pressure suits or mechanical counter-pressure suits alone.

The full pressure suit 300 can be constructed from numerous existing components used in historical or current high altitude flight suits and space suits, or from new approaches which simplify construction. The limiting factor in the performance of these suits is always the mobility joint performance at operational pressure. Operating at a lower pressure enables the mobility joints to be simplified to the point of being unique, which is what is described here.

The full pressure suit component 300 of the compression augmented full pressure suit 100 is designed with low pressure mobility joints 302 (FIG. 12) comprised of bladder 313, either of a thermally-welded coated fabric bladder, or a molded dipped bladder, and a sewn or woven textile restraint 312. The restraint 312 contains the bladder 313 and supports the structural loads, while the bladder 313 contains the inflation gas and is sized to fill the interior of the restraint 312 when pressurized. Typical pressure suit joints are constructed from assemblies of numerous patterned parts that are joined together to create mobility joints. Joints of this nature are typically expensive to construct and usually available only in standard sizes due to their complexity. Low pressure mobility joints 302 can be manufactured with new techniques in comparison with the state of the art because the stresses from pressurization are reduced. The restraint 312 can be sewn from patterned shapes, or woven in three-dimensional shapes. Textile webbings, tapes, or cords 314, 315, may also be applied externally to a simplified restraint shape that approximates the human form, to create indentations in the pressurized envelope. These indentations form convolutes as shown in FIG. 12 which enable flexure of the element. The webbings, tapes or cords 314, 315 are stitched such that the restraint fabric is gathered and provides the excess material to create the convolute. Another method of creating the convolutes is to sew the webbings, tapes, cords to a restraint that is fabricated from a material that can elongate. In this case the restraint grows into a convoluted shape when pressurized. The use of elastic materials in the restraint will also ease donning of the suit. In all cases, the webbings, tapes, or cords 314, 315 create an exoskeleton on top of the restraint which ultimately dictates the mobility of the suit. Application of the exoskeleton along “lines of non-extension” is one method of minimizing the torque of the joints. This is because “lines of non-extension” define locations on the human form that do not elongate with motion. The use of “lines of non-extension” in pressure suit design is not new but is informative when designing the exoskeleton.

The full-pressure suit 300 preferably includes a pressure-sealing zipper entry 309 for donning and doffing the suit. Several geometric configurations of zipper integration are possible because of the low operational pressure, and many have been incorporated in previous suits. The compression augmented full pressure suit contains a helical zipper entry at the waist that facilitates donning and doffing the suit while in a capsule. The upper 301 and lower halves 302 of the suit remain attached to one another by a strip of material (not shown) when open, but can be separated far enough to simplify entry and exit by the wearer. A separable pressure sealing zipper 310, 311 (similar to those used on jackets or Zip-Loc® bags), can also be used to facilitate complete separation of parts of the suit. This facilitates donning and doffing, but also reconfiguration of a suit with varying sized components to fit a large population with a controlled number of components. This strategy also allows the life of a suit to be extended beyond the life of its first component to become worn out.

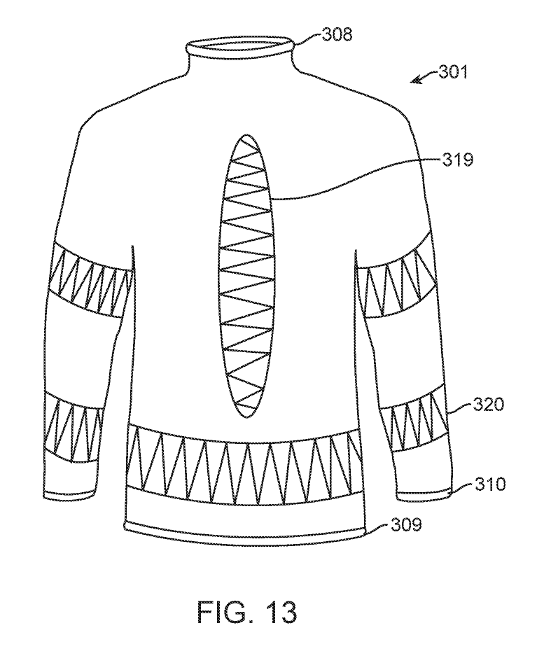

The compression augmented full pressure suit 100 can be custom fitted or comprised of standard sized elements. Minimizing the volumetric difference between the full-pressure suit 300 and the wearer, and attaining proper fit, contributes to joint torque reduction and improved performance, so being able to properly size the suit to the wearer is a critical factor in achieving optimal utility in the suit. Lacing strips (FIG. 13) are added to the arms, legs and torso in the circumferential and longitudinal direction of the full-pressure suit to facilitate alteration of the suits dimensions.

The full pressure suit has a helmet 306 that is connected to the upper torso 301 such that it closes the volume of the suit at the neck location, and restrains the loads from pressurization that try to lift the helmet 306 off the suit. The connection is separable so that the helmet can be worn without the suit for pre-breathing oxygen for bends' protection or, in some emergency situations including smoke or chemical exposure. The helmet 306 may contain a neck dam 307, which can be a separable element, or integral with the helmet 306, or upper torso portion 301, which creates a partition between the helmet volume and the suit volume, by sealing against the neck of the wearer. This facilitates the ability to have different pressures in the suit and helmet volumes. The pressure in the helmet 306 must be maintained at a level that accommodates the needs of human physiology. However, the suit pressure can be lower than the helmet pressure to enable greater mobility through a reduction in joint torque. Alternatively, the neck dam 307 can be provided as a separate component that interacts with the helmet 306 to permit the presence of different pressures in the suit from that supplied to the head of the wearer. A helmet 306 to suit 300 connection is provided at 308. Boot 304 to lower torso 302 connections are provided at 311. Similarly, glove 303 to upper torso 301 connections are provided at 310.

The compression garment is comprised of fibers (FIGS. 10-11) that are woven into three-dimensional shapes to fit the wearer, or manufactured from joined patterned shapes. The compression garment 200 can be made from elastic fibers 317, such as Lycra® that stretch when tensioned, or inelastic fibers 318, such as polyester, that are specially woven in tricot or similar weaves to facilitate stretch. These materials can be modified to include antimicrobial treatments for odor control, or surface modifications including coatings or nano-manipulation for wicking of sweat away from the body for cooling, or other functions. While it is within the scope of the embodiment to form a compression garment 200 from a single piece containing zippers, lacings or other separable connections to permit donning and doffing, the compression garment 200 is preferably made of multiple pieces, including an upper torso portion 201, a lower torso portion 202, gloves 203 and socks 204. Most preferably the upper torso portion 201 takes the form of a shirt and the lower torso portion 202 takes the form of pants. The upper torso portion 201 preferably is of the turtle neck 205, not crew, design. The different portions of the compression garment 200 may have sections that overlap, but can also be provided with connections to secure a portion to another portion, e.g., to secure a glove 203 to the upper torso portion 201.

A variety of compliant pads 201, 206-214, of different shapes and materials of construction, are strategically added to the compression garment 200 to fill the concavities on the body of the wearer (such as pads for the arm pits 208, small of the back 211, palm, groin 212, clavicles 207, back of the knee 214, elbow 209, buttocks 213 etc.), or reshape flat surfaces on the body, such as chest pad 206, upper back pad 210, lower back pad 211 to ensure uniform pressure application. They must move with the body so as to not limit motion, and not create “hot spots” that are uncomfortable. This is accomplished by making the pads from highly compliant materials such as gel-filled 216 bladders 215 (FIG. 7), foam 215 (FIGS. 8-9), or semi-rigid plastics that are articulated.

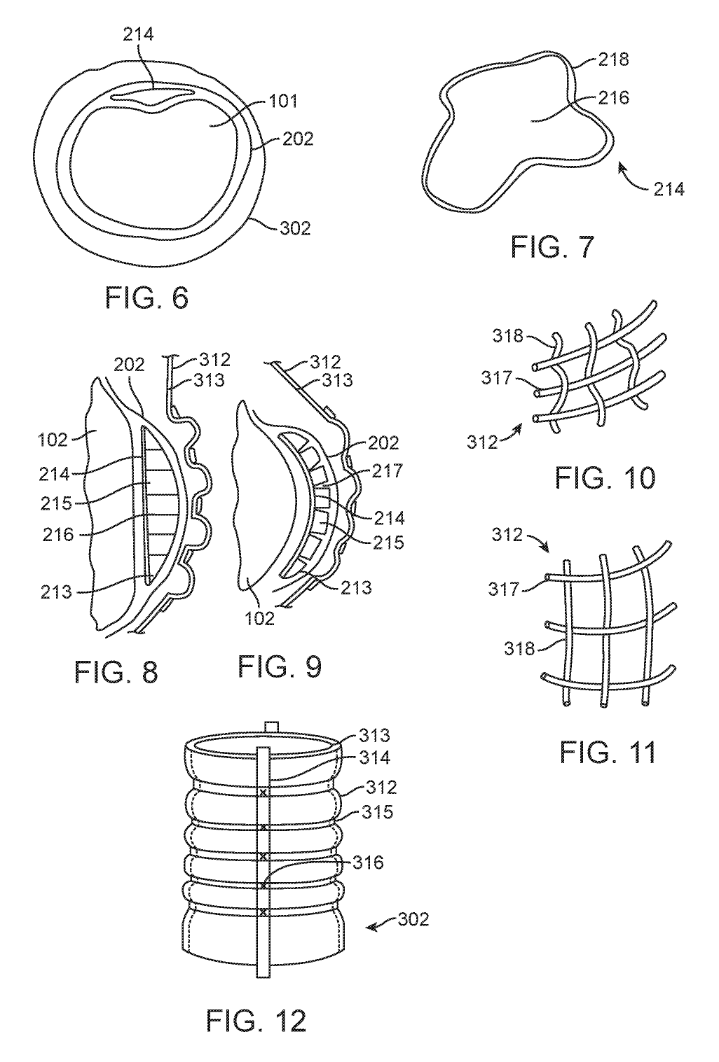

Gel or liquid filled bladders (FIG. 7), similar to breast implants, are incompressible and create a compliant surface that matches the changing contour of the body on one side and the elastic material on the other. Being incompressible is key to the function as this facilitates transfer of the externally applied pressure to the body in all directions. A typical construction, as shown in FIG. 7, comprises a pad bladder 218 which surrounds a pad filler or gel 216. It can be used in an elbow pad 209 or as a knee pad 214. The particular pad 214 shown in FIG. 7 is a knee pad which fits behind the knee as shown in FIGS. 5 and 6. It will be placed against the rear of the leg 101 of the wearer in the lower torso or pants portion 202. Of course, the knee pad 214 will be integrated into the compression garment 200 at the appropriate position such the when the pants or lower torso portion 202 is donned, it will be positioned against the rear portion of the leg 101 opposite the knee of the wearer as shown in FIG. 6. The lower torso portion 302 of full pressure suit 300 can also be seen in FIG. 6. This approach is best suited to areas with large geometric changes such as the armpit pad 208 or back of the knee pad 314 or elbow pad 209.

Three dimensional pads made from elastomeric materials or foam are another approach, and are best suited to flat areas such as the back, particularly upper back pad 210 and lower back pad 211 as shown in FIG. 3, or against the buttocks 102. These pads (shown in FIGS. 8 and 9) can comprise a foam 215, attached to a backer 214. Cuts or slits 216 in the body of foam 215 (FIG. 8) permit the foam 215 to form gaps 217 (FIG. 9) when flexed. The foam pad 215, which can be sliced partially through their thickness (FIG. 8-9) to facilitate the flexing while still transferring compression loads from the compression garment to the skin These pads of foam can be made by casting or machining processes, or by additive manufacturing. The inner surface 313 and outer surface 312 of lower torso portion 302 of full pressure suit 300 can also be seen in these figures.

The compression garment 200 can be a single garment that covers the entire body, or it can be manufactured in multiple sections. The single garment would require a zipper which is possible but may lead to discomfort. The more practical approach is to manufacture the compression garments in multiple components (shirt or upper torso 201, gloves 203, pants or lower torso 202, socks 204) that are separable to facilitate simple donning/doffing, and logistical simplification through replacement of worn or damaged components such as gloves 203 that will wear our faster than shirts 201. Each of these sections of the compression garment 200 needs to be closely tailored to the geometry of the wearer with their associated pads 201. To accomplish this, the wearer is three-dimensionally scanned, the data is loaded into a computer aided design package, pads 201, 206-214 are added, and the three-dimensional form of the ideal garment is generated. Patterns or weaving paths are generated from this form, and are then used to construct the garment.

A unique feature of the compression garment 200 for the compression augmented full pressure suit 100 is that the garment 200 only needs to apply the required compression in one axis of the body. This increases material options for garment solutions and increases wearer comfort and performance. For example, the compression garment 200 on the leg only needs to apply force through tightening of the circumferential fibers 317. The longitudinal fibers 318 do not have to apply compression and can therefore be designed to facilitate movement. Therefore, weaves can be structured that apply circumferential pressure to the leg, but at the same time do not limit flex of the knee. This yields the greatest mobility possible through torque reduction of the joint.

In addition to the various weaves that can be employed in the compression garments, reduction in the number of individual full pressure suit components 300 that must be created for a particular crew or mission can be reduced by employing the sizing features illustrated in FIG. 13. Although only the upper torso portion 301 of full pressure suit 300 is illustrated in FIG. 13, the same principles can be employed for the lower torso 302 portions as well. As shown in FIG. 13 circumferential sizing in upper torso 301 portion can be achieved by the provision of a circumferential sizing portion 319, operated by lacing strips, that when tightened, minimize the volume of the suit and when partially or fully released tend to increase the volume of the suit. Similarly, length sizing of the sleeve portions can be accommodated by one or more length adjusting portions 320, which also can employ lacing sections (two in number on each sleeve of the upper torso portion 301 of FIG. 13) but can be less than two or greater than two in number depending on the desired degree of adjustment. Similarly, the circumferential sizing section 319 shown in FIG. 13 can be duplicated on the back of the upper torso section 301 or could number in total, 1, 2, 3, 4 or more sections spaced about the torso portions to adjust the circumferential sizing of the suit. A reduction in the number of compression augmented full pressure suit 100 components is desirable from both a payload requirement, as well as interchangeability by various crew members of other crew members' suit portions.

Similarly, the compression garment 200 can incorporate multiple zippered or laced sections to alter the tension of the compression garment 200 on the wearer of the compression garment 200, of modify the size of the compression suit 200 (or a single component thereof) to accommodate the size of different wearers.

When viewed in environments of Mars exploration, or even extended space station activities, the provision of a fewer number of components that fit the body types of multiple different human forms is extremely desirable and reduces the need for custom or bespoke requirements of space suit production.

The compression garment 200 can be a simple passive garment that only applies the required compression to the skin, or it can be modified to include functionality. Examples of functionality can include thermal regulation (including tubes for carrying heated or cooled fluid or electrically heated conductors), biometric sensing, or performance monitoring. In some cases, a wire harness that carries power or signals from/to sensors to the life support system or other control devices, may be integrated directly into the garment itself by weaving in electronic textiles. Conductive fibers can be included in the weave patterns for this purpose. These fibers can be elastic in nature to stretch and conform similarly to the rest of the fibers in the compression garment, or can be inelastic and woven such that they have serpentine or zig-zag paths and do not limit the motion of the body as the whole garment changes shape. The electronic textiles can also be surface applied to the garment so as to be not directly integrated in the weave. Sensors, connectors, heaters, actuators, or even lights, can be attached to the electronic textiles to create the electronic network that forms the desired functionality.

It will be apparent to those persons skilled in the art, upon reading my description of the various embodiments described herein, that various modifications and alterations of the disclosed embodiments can be envisioned and implemented without departing from the scope and spirit of the appended claims.

I claim:

1) A compression augmented space suit system that comprises:
a compression garment worn under a full-pressure suit, wherein:
the combination of the compressive force exerted by the compression garment and the internal pressure of the full pressure suit combine to provide the required physiological compression to the body to prevent the evolution of gas under the skin of a wearer when exposed to a low/no pressure environment, and;
further comprising a helmet to cover the head and a neck seal to separate a suit volume from a helmet volume such that the helmet volume can be pressurized to a pressure different from the pressurization of the full pressure suit permitting the helmet volume to operate at a higher pressure than the pressure in the suit volume.

2) The compression augmented space suit system of claim 1, wherein the compression garment comprises an elastic fabric and applies compression to the skin because it is undersized as compared to the body of the wearer.

3) The compression augmented space suit system of claim 1, wherein the compression garment comprises a tricot woven fabric and applies compression to the skin because it is undersized as compared to the body.

4) The compression augmented space suit system of claim 1, wherein the compression garment can be selected from the group consisting of a single piece garment and a multiple piece garment which multiple piece garment is comprised of sections which overlap or are attached to one another to cover the human form.

5) The compression augmented space suit system of claim 1, wherein the compression garment comprises multiple zippers which can be opened and closed to facilitate donning or altering the tension in the garment for variability of pressure application.

6) The compression augmented space suit system of claim 1, wherein the compression garment comprises multiple adjacent zippers which can be matched to facilitate sizing the garment.

7) The compression augmented space suit system of claim 1, wherein the compression garment incorporates multiple lacing strips which can be opened and closed to facilitate donning/doffing and altering the tension in the garment for variability of pressure application

8) The compression augmented space suit system of claim 1, wherein the compression garment comprises compliant three-dimensional (3D) components that fill the concavities of the human anatomy and facilitate the application of pressure to the body from the garment

9) The compression augmented space suit system of claim 1, wherein the compression garment is three-dimensionally woven to eliminate seams

10) The compression augmented space suit system of claim 1, wherein the compression garment is seamed together from patterned parts

11) The compression augmented space suit system of claim 1, wherein the compression garment incorporates a tube system that carries heated or chilled fluid for thermal regulation of the body

12) The compression augmented space suit system of claim 1, wherein the compression garment incorporates a physiological monitoring system that senses the wearer's biometric data

13) The compression augmented space suit system of claim 1, wherein the full pressure suit comprises at least one of a circumferential and a longitudinal lacing feature for sizing and minimization of internal volume

14) The compression augmented space suit system of claim 1 where the internal pressure of the full pressure suit can be altered during wearing of the suit

15) The compression augmented space suit system of claim 1 where the helmet can be worn without the rest of the full pressure suit to facilitate pre-breathing or emergency protection

16) The pressure augmented space suit system of claim 1 where the patterns used to create the compression garment are created from digital data of the human form obtained by at least one selected from the group consisting of laser scanning and photo-optical methods.

17) The compression augmented space suit system of claim 8, wherein the compliant three-dimensional (3D) components are at least one selected from the group consisting of rigid materials and highly flexible materials.

18) The compression augmented space suit system of claim 17, wherein the highly flexible materials are at least one selected from the group consisting of a foam, a gel-filled bladder and a liquid filled bladder.

19) The compression augmented space suit system of claim 18, wherein the foam, the liquid filled bladder or the gel-filled bladder is in the form of pads, which pads are integrated with the compression garment.

20) The compression augmented space suit system of claim 1, wherein the compression garment comprises a fabric that is highly elastic in one direction only and applies compression to the body in the circumferential direction only.
